(19) United States
(12) Patent Application Publication
(10) Pub. No.: US 2019/0116795 A1
(43) Pub. Date: Apr. 25, 2019

(54) USE OF TENVERMECTIN IN CONTROL OF HARMFUL INSECTS IN AGRICULTURAL AND FOREST CROPS

(71) Applicant: ZHEJIANG HISUN PHARMACEUTICAL CO., LTD., Taizhou city, Zhejiang (CN)

(72) Inventors: Jun HUANG, Taizhou city, Zhejiang (CN); Jidong WANG, Taizhou city, Zhejiang (CN); Hui ZHANG, Taizhou city, Zhejiang (CN); Liang SHEN, Taizhou city, Zhejiang (CN); Meihong LI, Taizhou city, Zhejiang (CN); Jiatan LIN, Taizhou city, Zhejiang (CN); Lingjian ZHANG, Taizhou city, Zhejiang (CN); Lingping WANG, Taizhou city, Zhejiang (CN)

(21) Appl. No.: 16/091,326

(22) PCT Filed: Mar. 31, 2017
(86) PCT No.: PCT/CN2017/079063

§ 371 Date: Oct. 4, 2018

(30) Foreign Application Priority Data
Apr. 7, 2016 (CN) 201610211064.5

(51) Int. Cl. A01N 43/90

(52) U.S. Cl. CPC A01N 43/90

(57) ABSTRACT

Disclosed herein are compounds tenvermectin A and B and mixtures of compounds tenvermectin A and B for the control of harmful insects in agricultural and forest crops. The tenvermectin A and/or the tenvermectin B of the present invention have a significant control effect on harmful insects in agricultural and forest crops, for example, Bemisia tabaci, Frankliniella occidentalis Pergande, Laodelphax striatellus, Nilaparvata lugens, Sogatella furcifera, Cnaphalocrocis medinalis, rice Chilo suppressalis, rice Scirpophaga incertulas and Coptotermes formosanus Shiraki, and have low toxicity, and are more environmentally friendly and have good application prospects.

### TECHNICAL FIELD

The present invention relates to a novel use of tenvermectin A and/or tenvermectin B for controlling harmful insects in agricultural and forest crops.

### TECHNICAL BACKGROUND

The 16-membered macrolide compounds produced by Streptomyces have high activity and broad spectrum characteristics, and have been widely used in the control of pests and pest mites of agricultural and forest plants. At the summary meeting of the high-toxic pesticide substitution demonstration project held in 2008, for seven crop (such as rice) pests and diseases, experts recommended 28 pesticides such as abamectin as the fourth batch of substitutes of five high-toxic pesticides (methamidophos, parathion, parathion-methyl, moncrotophos and phosphamidon), and announced 56 supporting technologies. Abamectin, a class of 16-membered macrolide compounds with insecticidal, acaricidal and nematicidal activities first developed by Satoshi δmura from Kitasato University of Japan and Merck Inc. of the United States, is a new type of antibiotics. It is produced by the fermentation of Streptomyces avermitilis in Streptomyces. After the five high-toxic pesticides were banned, abamectin showed a rapid development momentum and increased usage, and became a common variety of agricultural drugs in China. With the increasing popularity of abamectin, the resistance of pests to abamectin products has increased, and its dosage has also increased. In the domestic market, in 1995, the dilution ratio of 1.8% abamectin preparation against non-resistant pests is 15000 times, and now the dilution ratio of 1.8% abamectin preparation to control pests is 2000-3000 times. Compared with abamectin, emamectin benzoate is more active, and has less residue, lower toxicity and better safety. It is the future development direction of abamectin, but it does not solve the potential danger to aquatic organisms. The newly marketed milbemycin is more toxic to aquatic organisms than abamectin and emamectin benzoate.

Due to the high toxicity to aquatic organisms, the rice market has always been the forbidden place for abamectin in the past. Although the state has passed its provisional decree on rice, giving abamectin a position in the control of rice pests and diseases, its toxicity on aquatic organisms such as fish is highly toxic, and its registration use on rice is a potential danger to aquatic organisms. The amount of 1-2 g per mu of rice will not cause harm to aquatic organisms. However, if drug resistance emerges, the user will inevitably increase the amount of preparation used, which will pose a threat to the safety of aquatic organisms. As a result, the state's provisional decree on the use of abamectin on field crops may be withdrawn. In addition, in the field of agriculture, China will vigorously promote the application of green pesticides such as biological pesticides and promote the development of high-efficient green agriculture. Therefore, the development of new high-efficient, low-toxic, low-residue pesticide varieties for rice are of utmost urgency.

CN201410208660.9 discloses a compound of formula (I) below:

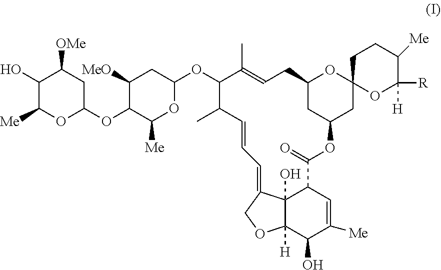

wherein R is selected from CH₃ or C₂H₅, and the compound of formula (I) is tenvermectin A when R is —CH₃, and the compound of formula (I) is tenvermectin B when R is C₂H₅. The patent application also discloses that the compounds of formula (I) have an effect of controlling pests and pest mites of agricultural and forest crops, such as Tetranychus cinnabarinus, Tetrangchus urticae Koch, Plutella Xylostella Linnaeus, Spodoptera exigua Hubner, Spodoptera litura Fabricius, Helicoverpa armigera Hubner, Agrotis ipsilon, wireworm, armyworm, Pine caterpillars, Bursaphelenchus xylophilus, and rice stem borer. However, the application does not disclose the differences in pharmacological toxicity and pharmacological activity between tenvermectin A and tenvermectin B.

### SUMMARY OF THE INVENTION

In one aspect, the present invention provides use of a compound of formula (I) below for the preparation of a medicament for controlling harmful insects in agricultural and forest crops:

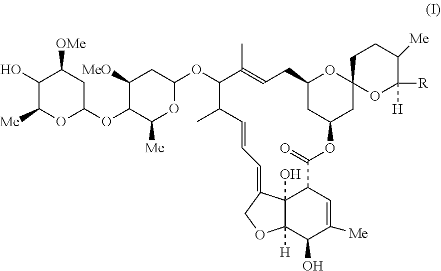

wherein R is selected from CH₃ or C₂H₅, and the compound of formula (I) is tenvermectin A when R is CH₃, and the compound of formula (I) is tenvermectin B when R is C₂H₅.

The compounds of formula (I) in the present application are effective against commonly sensitive and resistant species and their entire or individual developmental stages.

In a preferred embodiment, the agricultural and forest crop is selected from the group consisting of rice, cotton, tea, vegetables, sugarcane, soybeans, potatoes, fruit trees, fruits of fruit trees, corn, vines, ornamental plants, pasture and herbage, or canola.

In a preferred embodiment, the agricultural and forest crop is selected from the group consisting of rice, cotton, vegetables, fruit trees, or ornamental plants.

In a preferred embodiment, the harmful insect is selected from the group consisting of:

Blattaria, for example, Blatta orientalis, Periplaneta americana, Leucophaea maderae, Blattella germanica, Coptotermes formosanus Shiraki;

Phthiraptera, for example, Pediculus humanus corporis, Haematopinus spp., Linognathus spp., Trichodectes spp., Damalinia spp.;

Thysanoptera, for example, Hercinothrips femoralis, Thrips tabaci, Thrips palmi, Frankliniella occidentalis, Frankliniella occidentalis Pergande;

Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Saissetia oleae, Laodelphax striatellus, Nilaparvata lugens, Bemisia tabaci, Aonidiella aurantii, Aspidiotus hederae, Pseudococcus spp., Psylla spp., Sogatella furcifera;

Hymenoptera, for example, Diprion spp., Hoplocampa spp., Lasius spp., Monomorium pharaonis, Vespa spp.;

Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella fit, Phorbia spp., Pegomyiahyoscyami, Ceratitis capitata, Dacusoleae, Tipula paludosa, Hylemyia spp., Liriomyza spp.;

Hemiptera, for example, Belostomatidae, Corixidae, Nepidae, Notonectidae, Cydnidae, Pentatomidae, Scutelleridae, Plataspiddae, Coreidae, Lygaeidae, Pyrrhocoridae, Miridae, Tingididae, Reduviidae, Anthocoridae, Saldidae, Cimicidae), Gerridae;

Siphonaptera, for example, Xenopsylla cheopis, Ceratophyllus spp., Arachnida, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.;

Plant parasitic nematodes, for example, Pratylenchus spp., Radopholus similis, Ditylenchusdipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.;

oriental armyworm, gamasid mite, Eriophyidae.

In a preferred embodiment, the harmful insect is selected from the group consisting of: Blattaria, Thysanoptera, Homoptera or Hemiptera.

In a preferred embodiment, the harmful insect is selected from the group consisting of: Bemisia tabaci, Frankliniella occidentalis Pergande, Laodelphax striatellus, Nilaparvata lugens, Sogatella furcifera, Cnaphalocrocis medinalis, rice Chilo suppressalis, rice Scirpophaga incertulas or Coptotermes formosanus Shiraki.

In a preferred embodiment, harmful insect is selected from the group consisting of: Laodelphax striatellus, Nilaparvata lugens or Sogatella furcifera, and wherein the compound of formula (I) is a mixture of tenvermectin A and tenvermectin B.

In a preferred embodiment, the harmful insect is selected from the group consisting of: Cnaphalocrocis medinalis, rice Chilo suppressalis or rice Scirpophaga incertulas, and wherein the compound of formula (I) is a mixture of tenvermectin A and tenvermectin B.

In a preferred embodiment, the weight ratio of tenvermectin A and tenvermectin B in the mixture is ≥9:1, preferably ≥19:1.

The present inventors have surprisingly found that although the structures of tenvermectin A and tenvermectin B are very similar, the toxicity of tenvermectin B to aquatic organisms (for example, zebrafish, algae, and Daphnia magna, etc.) is significantly higher than that of tenvermectin A. The toxicity of tenvermectin A to aquatic organisms is merely in moderate level. More surprisingly, tenvermectin A and tenvermectin B are not much different with respect to the control spectrum against pests and diseases and the activities thereof. In the present application, by controlling the ratio of the two components, tenvermectin A and tenvermectin B, the toxicity of the mixture of tenvermectin A and tenvermectin B to aquatic organisms can be greatly reduced. When the weight ratio of tenvermectin A to tenvermectin B in the mixture is ≥9:1, especially when the weight ratio is ≥19:1, the toxicity of the mixture to aquatic organisms is greatly reduced, merely in moderate level, while the killing effect on harmful insects in agricultural and forest crops remains almost unchanged. Therefore, it has the characteristic of green environmental protection. Moreover, compared with abamectin, ivermectin and milbemycin, tenvermectin A and/or tenvermectin B of the present invention have a more significant killing effect on pests and parasites, and they are less toxic to aquatic organisms, and they have better application prospects.

The compound of formula (I) according to the present invention can be prepared into a conventional preparation form. The conventional preparation forms include, for example, solutions, emulsions, wettable powders, water-dispersible granules, suspensions, powders, foams, pastes, tablets, granules, aerosols, natural and synthetic products impregnated with active compounds, microcapsules, seed coatings, preparations using burning devices (the burning devices include, for example, fumigation cylinders and smoking cylinders, smoking cans and smoking rings) and ultralow volume sprays (cold aerosol, hot aerosol).

These preparations can be prepared by known methods in the art. For example, they can be prepared by mixing the active compound with the spreader, i.e., mixing with a liquid diluent or carrier, a liquefied gas diluent or carrier, a solid diluent or carrier, and optionally using a surfactant, i.e., an emulsifier and/or a dispersing agent and/or a foaming agent.

When water is used as a spreader, for example, an organic solvent can be used as a co-solvent. The liquid diluent or carrier can include, for example, aromatic hydrocarbons (e.g., xylene, toluene, alkylnaphthalene, etc.), chlorinated aromatic hydrocarbons, or chlorinated aliphatic hydrocarbons (e.g., chlorobenzene, ethylene chloride, dichloromethane, etc.), aliphatic hydrocarbons (e.g., cyclohexane or paraffin (e.g., mineral oil fractions)), alcohols (e.g., butanol, ethylene glycol and ethers or esters thereof), ketones (e.g., acetone, methyl ethyl ketone, methyl isobutyl ketone, cyclohexanone, etc.), strong polar solvents (e.g., dimethylformamide, dimethyl sulfoxide, etc.), water, and the like.

The liquefied gas diluent or carrier can include a substance that exists as gas at ambient temperature and pressure, for example, an aerosol spray (such as furan, propane, nitrogen, carbon dioxide, halogenated hydrocarbons).

The solid diluent can include, for example, pulverized natural minerals (for example, kaolin, clay, talc, chalk, quartz, attapulgite, montmorillonite or diatomaceous earth, etc.), pulverized synthetic minerals (for example, finely dispersed silicic acid, aluminum oxide, silicate, etc.).

The granular solid carrier can include, for example, pulverized and graded rocks (for example, calcite, marble, pumice, sepiolite, dolomite, etc.), particles of synthetic inorganic or organic powders, and fine particles of organics (for example, sawdust, coconut shell, corncob, tobacco stems, etc.).

The emulsifier and/or foaming agent can include, for example, nonionic or anionic emulsifiers (for example, polyoxyethylene fatty acid esters, polyoxyethylene aliphatic alcohol ether (for example, alkyl aryl polyethylene glycol ethers), alkyl sulfonate, alkyl sulfate, aryl sulfonate, etc.), albumin hydrolysate, and the like.

The dispersing agent, such as one or more of polycarboxylate, lignosulfonate, alkylnaphthalenesulfonate (diffusion agent NNO), TERSPERSE 2020 (manufactured by Huntsman, Inc., alkyl naphthalene sulfonates) etc.

Binders can also be used in preparations (powders, granules, emulsions), for example, carboxymethylcellulose, natural or synthetic polymers (e.g., arabic gum, polyvinyl alcohol, polyvinyl acetate, etc.) and the like.

Coloring agents, for example, inorganic pigments (e.g., iron oxide, titanium oxide, Prussian blue, etc.), organic pigments (e.g., alizarin dyes, azo dyes or metal phthalocyanine dyes), and microelements (e.g., ferric salt, manganese salt, boron salt, copper salt, cobalt salt, molybdenum salt or zinc salt, etc.) can also be used.

The preparations can contain 0.1-99% by weight, preferably 0.5-90% by weight of the abovementioned active compounds.

### EMBODIMENTS

The present invention is further illustrated by the following examples, which are intended to illustrate the invention and are not to be construed as limiting the invention.

### Example 1: Killing Effect of Tenvermectin on Bemisia tabaci

Test agents:

92% Abamectin (Zhejiang Qianjiang Biochemical Co., Ltd.);

96% Acetamiprid (Zhejiang Hisun Chemical Co., Ltd.);

91% Milbemycin original medicines (Zhejiang Hisun Chemical Co., Ltd.);

95% Tenvermectin A (Zhejiang Hisun Pharmaceutical Co., Ltd.).

Each original medicine was dissolved in DMF and formulated into a 10000 mg/L solution for later use.

The liquid membrane impregnation method of blades was used. Each agent was diluted with tap water to solutions of 0.25 mg/L, 0.5 mg/L, 1.0 mg/L, 2.5 mg/L, 5.0 mg/L, 10 mg/L and 20 mg/L. Fresh tomato leaves were taken and placed in the solutions to leave them to soak for 5 s and then taken them out and dried them indoors. One tomato leaf was placed in each culture dish. Three repetitions per treatment, a leaf was soaked with water, dried, and then was placed in a culture dish to be used as a control. The Bemisia tabaci imagoes were gently patted into the culture dish, about 30 to 40 imagoes in each dish. The dishes were sealed with plastic wrap, several small holes were made on the plastic wrap to facilitate ventilation. After 24 hours, the death of Bemisia tabaci imagoes was checked under a binocular microscope (the anatomical needle was used to gently touch the Bemisia tabaci imagoes, and the motionless ones were regarded to be dead). Experimental data statistics and analysis were performed with spss 19 software.

The relative toxicity index of the agent having the largest LC₅₀ was set to be 1, and the relative toxicity index of each agent was determined by dividing the maximum LC₅₀ by the LC₅₀ value of each agent.

The indoor toxicities against Bemisia tabaci imagoes of the above four agents are shown in Table 1.

TABLE 1
Indoor toxicities of different agents against Bemisia tabaci imagoes

| | Toxicity | Chi-square | Correlation | | |
|---|---|---|---|---|---|
| Agents used | regression | value | coefficient | LC₅₀ | Relative |
| in treatment | equation | x² | (r) | (mg/L) | toxicity |
| 96% | Y = −0.801 + | 1.739 | 0.9950 | 2.541 | 1 |
| Acetamiprid | 1.977X | | | | |
| 92% | Y = 1.332 + | 5.541 | 0.9762 | 0.225 | 11.293 |
| Abamectin | 2.059X | | | | |
| 91% | Y = 1.514 + | 6.288 | 0.9910 | 0.210 | 12.100 |
| Milbemycin | 2.233X | | | | |
| 95% | Y = 3.341 + | 3.97 | 0.9828 | 0.023 | 110.478 |
| Tenvermectin | 2.033X | | | | |
| A | | | | | |

As can be seen from Table 1, acetamiprid was used as a standard agent, the relative toxicity index thereof was set to be 1, and the relative toxicity index of tenvermectin A was 110.478, which was the most toxic to Bemisia tabaci imagoes, and the toxicity of tenvermectin A was much higher than those of the other three agents. It can be seen that, tenvermectin A had higher activity against Bemisia tabaci and was superior to the other three agents.

### Example 2: Killing Effect of Tenvermectin on Laodelphax striatellus

Test agents:

92% Abamectin (Zhejiang Qianjiang Biochemical Co., Ltd.);

98% Imidacloprid (Zhejiang Hisun Chemical Co., Ltd.);

95% Lambda-cyhalothrin (Jiangsu Jianpai Pesticide Chemical Co., Ltd.);

95% Tenvermectin A (Zhejiang Hisun Pharmaceutical Co., Ltd.).

Each original medicine was dissolved in DMF and formulated into a 10000 mg/L solution for later use.

Test insect source: The Laodelphax striatellus imagoes were collected in the rice fields of Jiaxing, Zhejiang, and were raised indoors with rice seedlings.

The soaking seedling method was used in this test. The test agents were diluted with tap water into five series of concentrations on the basis of pre-test to be used as test solutions. Specifically, lambda-cyhalothrin and imidacloprid were diluted to 5 mg/L, 10 mg/L, 25 mg/L, 50 mg/L and 100 mg/L; abamectin was diluted to 0.25 mg/L, 0.5 Mg/L, 1.0 mg/L, 2.5 mg/L and 5.0 mg/L; tenvermectin A was diluted to 0.05 mg/L, 0.10 mg/L, 0.25 mg/L, 0.5 mg/L and 1.0 mg/L. Rice seedlings that are sown indoors for about 25 days and have no rice planthopper eggs were taken, a few rice roots were left, the seedlings were soaked in pre-formed solution for 30 seconds then they were taken out and dried, and were put into a 3 cm×20 cm test tube. There was a little water at the bottom of the tube. 2-3 rice seedlings per tube, three repetitions per treatment, and the one treated with water was used as a control. Each tube receives 40-50 heads of Laodelphax striatellus, and the tubes were sealed with black cloth and were placed in a worm room under a temperature of (26±1) ° C. After 72 hours of treatment, the number of dead insects was checked. The test with a control mortality less than 10% is an effective test. Experimental data statistics and analysis were performed using spss 19 software.

The relative toxicity index of the agent having the largest LC₅₀ was set to be 1, and the relative toxicity index of each agent was determined by dividing the maximum LC₅₀ by the LC₅₀ value of each agent.

The indoor toxicities against Laodelphax striatellus imagoes of the above four agents are shown in Table 2.

TABLE 2
Indoor toxicities of different agents against Laodelphax striatellus
imagoes.

| | Toxicity | Chi-square | Correlation | | |
|---|---|---|---|---|---|
| Agents used | regression | value | coefficient | LC₅₀ | Relative |
| in treatment | equation | x² | (r) | (mg/L) | toxicity |
| 98% | Y = −2.922 + | 1.509 | 0.9965 | 31.817 | 1 |
| Imidacloprid | 1.945X | | | | |
| 92% | Y = −0.977 + | 9.193 | 0.9803 | 3.101 | 10.260 |
| Abamectin | 1.988X | | | | |
| 95% | Y = −1.503 + | 3.563 | 0.9864 | 12.017 | 2.648 |
| Lambda- | 1.392X | | | | |
| cyhalothrin | | | | | |
| 95% | Y = 0.900 + | 6.496 | 0.9813 | 0.296 | 107.490 |
| Tenvermectin | 1.703X | | | | |
| A | | | | | |

As can be seen from Table 2, imidacloprid was used as a standard agent, the relative toxicity index thereof was set to be 1, and the relative toxicity index of tenvermectin A was 107.490, which was the most toxic to Bemisia tabaci imagoes, and the toxicity of tenvermectin A was much higher than those of the other three agents. It can be seen that, tenvermectin A had higher activity against Laodelphax striatellus and was superior to the other three agents.

### Example 3: Killing Effect of Tenvermectin on Nilaparvata lugens

Test agents:

92% Abamectin (Zhejiang Qianjiang Biochemical Co., Ltd.);

98% Imidacloprid (Zhejiang Hisun Chemical Co., Ltd.);

95% Lambda-cyhalothrin (Jiangsu Jianpai Pesticide Chemical Co., Ltd.);

Tenvermectin (Tenvermectin A: Tenvermectin B=7:3 (weight ratio)) (Zhejiang Hisun Pharmaceutical Co., Ltd.).

Each original medicine was dissolved in DMF and formulated into a 10000 mg/L solution for later use.

Test insect source: the Nilaparvata lugens imagoes were collected from the rice field in Jiaxing, Zhejiang and were raised indoors with rice seedlings.

The soaking seedling method was used in this test. The test agents were diluted with tap water into five series of concentrations on the basis of pre-test to be used as test solutions. Specifically, both lambda-cyhalothrin and imidacloprid were diluted to 5 mg/L, 10 mg/L, 25 mg/L, 50 mg/L and 100 mg/L; abamectin was diluted to 0.25 mg/L, 0.5 mg/L, 1.0 mg/L, 2.5 mg/L and 5.0 mg/L; tenvermectin (tenvermectin A: tenvermectin B=7:3) was diluted to 0.05 mg/L, 0.10 mg/L, 0.25 mg/L, 0.5 mg/L and 1.0 mg/L. Rice seedlings that are sown indoors for about 25 days and have no rice planthopper eggs were taken, a few rice roots were left, the seedlings were soaked in pre-formed solution for 30 seconds then they were taken out and dried, and were put into a 3 cm×20 cm test tube. There was a little water at the bottom of the tube. 2-3 rice seedlings per tube, three repetitions per treatment, and the one treated with water was used as a control. Each tube receives 40-50 heads of Laodelphax striatellus, and the tubes were sealed with black cloth and were placed in a worm room under a temperature of (26±1) ° C. After 72 hours of treatment, the number of dead insects was checked. The test with a control mortality less than 10% is an effective test. Experimental data statistics and analysis were performed using spss 19 software.

The relative toxicity index of the agent having the largest LC₅₀ was set to be 1, and the relative toxicity index of each agent was determined by dividing the maximum LC₅₀ by the LC₅₀ value of each agent.

The indoor toxicities against Nilaparvata lugens imagoes of the above four agents are shown in Table 3.

TABLE 3
Indoor toxicities of different agents against Nilaparvata lugens imagoes

| | Toxicity | Chi-square | Correlation | | |
|---|---|---|---|---|---|
| Agents used | regression | value | coefficient | LC₅₀ | Relative |
| in treatment | equation | x² | (r) | (mg/L) | toxicity |
| Imidacloprid | Y = −2.082 + | 3.033 | 0.9869 | 33.874 | 1 |
| | 1.361X | | | | |
| Abamectin | Y = −0.883 + | 11.997 | 0.9721 | 3.062 | 11.063 |
| | 1.817X | | | | |
| Lambda- | Y = −1.757 + | 2.604 | 0.9905 | 17.709 | 1.923 |
| cyhalothrin | 1.408X | | | | |
| Tenvermectin | Y = 0.642 + | 2.007 | 0.9925 | 0.339 | 99.923 |
| (Tenvermectin | 1.368X | | | | |
| A: | | | | | |
| Tenvermectin | | | | | |
| B = 7:3) | | | | | |

As can be seen from Table 3, imidacloprid was used as a standard agent, the relative toxicity index thereof was set to be 1, and the relative toxicity index of tenvermectin (tenvermectin A: tenvermectin B=7:3) was 99.923, which was the most toxic to Nilaparvata lugens imagoes, and the toxicity of tenvermectin (tenvermectin A: tenvermectin B=7:3) was much higher than those of the other three agents. It can be seen that, tenvermectin (tenvermectin A: tenvermectin B=7:3) had higher activity against Laodelphax striatellus and was superior to the other three agents.

### Example 4: Killing Effect of Tenvermectin on Frankliniella occidentalis

Pergande.

Test agents:

92% Abamectin (Zhejiang Qianjiang Biochemical Co., Ltd.);

98% Imidacloprid (Zhejiang Hisun Chemical Co., Ltd.);

90% Methylamino abamectin benzoate (Emamectin benzoate) (Zhejiang Shenghua Biok Biology Co., Ltd.);

Tenvermectin Mixture I (Tenvermectin A: Tenvermectin B=9:1) (Zhejiang Hisun Pharmaceutical Co., Ltd.),

Tenvermectin Mixture II (Tenvermectin A: Tenvermectin B=1:9) (Zhejiang Hisun Pharmaceutical Co., Ltd.).

Each original medicine was dissolved in DMF and formulated into a 10000 mg/L solution for later use.

The impregnation method was used. The test agents were diluted with tap water into five series of concentrations on the basis of pre-test to be used as test solutions. Specifically, imidacloprid was diluted to 5 mg/L, 10 mg/L, 25 mg/L, 50 mg/L and 100 mg/L; abamectin was diluted to 0.25 mg/L, 0.5 mg/L, 1.0 mg/L, 2.5 mg/L and 5.0 mg/L; emamectin benzoate, tenvermectin mixture I and tenvermectin mixture II were all diluted to 0.05 mg/L, 0.10 mg/L, 0.25 mg/L, 0.5 mg/L and 1.0 mg/L. The bottom of the insect box was immersed in the prepared solution by 1 cm to allow the solution to enter the insect box through the copper net. The quantitative Frankliniella occidentalis Pergande (15-20 heads) in the suction trap were flicked into the solution in the insect box, and the solution was gently stirred with a glass rod for 10 seconds, and the insect box was quickly removed from the solution, and when the solution was drained out from the insect box, the residual solution on the copper net was blotted with absorbent paper from the bottom of the insect box, and then a 3 cm long kidney bean slice (Frankliniella occidentalis Pergande feed) was put into the insect box, and finally the insect box was sealed with a parafilm. Each treatment was repeated 3 times, and the one treated with water was used as a blank control. The sealed insect box was placed in a HPG280H light incubator under a temperature of 26° C. and a humidity of 70%. The death of Frankliniella occidentalis Pergande was checked 48 hours after medication, and the test with a control mortality less than 10% is an effective test. Experimental data statistics and analysis were performed using spss 19 software.

The relative toxicity index of the agent having the largest LC₅₀ was set to be 1, and the relative toxicity index of each agent was determined by dividing the maximum LC₅₀ by the LC₅₀ value of each agent.

The indoor toxicities against Frankliniella occidentalis Pergande imagoes of the above five agents are shown in Table 4.

TABLE 4
Indoor toxicities of different agents against Frankliniella occidentalis
Pergande imagoes

| | Toxicity | Chi-square | Correlation | | |
|---|---|---|---|---|---|
| Agents used | regression | value | coefficient | LC₅₀ | Relative |
| in treatment | equation | x² | (r) | (mg/L) | toxicity |
| 98% | Y = −3.874 + | 8.668 | 0.9545 | 39.081 | 1 |
| Imidacloprid | 2.434X | | | | |
| 92% | Y = −1.039 + | 4.734 | 0.9839 | 2.648 | 14.759 |
| Abamectin | 2.458X | | | | |
| 90% | Y = 1.260 + | 7.155 | 0.9788 | 0.318 | 122.896 |
| Methylamino | 2.530X | | | | |
| abamectin | | | | | |
| benzoate | | | | | |
| (Emamectin | | | | | |
| benzoate) | | | | | |
| Tenvermectin | Y = 1.562 + | 6.181 | 0.9818 | 0.251 | 155.701 |
| mixture I | 2.602X | | | | |
| Tenvermectin | Y = 2.214 + | 2.662 | 0.9930 | 0.155 | 252.135 |
| mixture II | 1.795X | | | | |

As can be seen from Table 4, imidacloprid was used as a standard agent, the relative toxicity index thereof was set to be 1, and the relative toxicity index of tenvermectin mixture II was 252.135, which was the most toxic to Frankliniella occidentalis Pergande imagoes, and the toxicity of tenvermectin mixture II was much higher than those of imidacloprid, abamectin and emamectin benzoate; the relative toxicity index of tenvermectin mixture I was 155.701, which was relatively high-toxic to Frankliniella occidentalis Pergande imagoes, and the toxicity of tenvermectin mixture I was much higher than those of imidacloprid, abamectin and emamectin benzoate. It can be seen that, tenvermectin mixture I and tenvermectin mixture II had higher activity against Frankliniella occidentalis Pergande and were superior to the other three agents.

### Example 5: Killing Effect of Tenvermectin on Coptotermes formosanus Shiraki

Test agents:

92% Abamectin (Zhejiang Qianjiang Biochemical Co., Ltd.);

95% Tenvermectin A (Zhejiang Hisun Pharmaceutical Co., Ltd.);

92% Tenvermectin B (Zhejiang Hisun Pharmaceutical Co., Ltd.).

Each original medicine was dissolved in DMF and formulated into a 10000 mg/L solution for later use.

Method: the test agents were diluted with tap water into five series of concentrations on the basis of pre-test to be used as test solutions. Specifically, abamectin was diluted to 0.01 mg/L, 0.025 mg/L, 0.05 mg/L, 0.10 mg/L and 0.25 mg/L; tenvermectin A and tenvermectin B were diluted to 0.001 mg/L, 0.0025 mg/L, 0.005 mg/L, 0.01 mg/L and 0.025 mg/L. The termites to be tested were placed in culture dishes with a diameter of 15 cm, and 20 worker ants were placed in each dish. During the test, a microinjector was used to drop 1 μI of the solution to the thorax and abdome of each termite for a total of 3 repetitions. One fungus comb was placed in each dish for termites to inhabit and a wet absorbent cotton ball was placed to moisturize. After completing dropping the solution, the culture dish was placed in a chamber under a constant temperature of 18±1° C. and a constant humidity and was cultivated in dark conditions, the death conditions were observed 24 hours and 48 hours after dropping the solution respectively. A writing brush was used to touch the various parts of the bodies of the termites and the termites that are completely immobile were judged to be dead. Experimental data statistics and analysis were performed using spss 19 software.

The relative toxicity index of the agent having the largest LC₅₀ was set to be 1, and the relative toxicity index of each agent was determined by dividing the maximum LC₅₀ by the LC₅₀ value of each agent.

The indoor toxicities against Coptotermes formosanus Shiraki of the three agents are shown in Table 5.

TABLE 5
Indoor toxicities of different agents against Coptotermes formosanus
Shiraki

| | Toxicity | Chi-square | Correlation | | |
|---|---|---|---|---|---|
| Agents used | regression | value | coefficient | LC₅₀ | Relative |
| in treatment | equation | x² | (r) | (mg/L) | toxicity |
| 92% | Y = 2.607 + | 6.135 | 0.9726 | 0.041 | 1 |
| Abamectin | 1.878X | | | | |
| 95% | Y = 3.507 + | 1.457 | 0.9845 | 0.0086 | 4.77 |
| Tenvermectin | 1.699X | | | | |
| A | | | | | |
| 92% | Y = 4.358 + | 6.283 | 0.9828 | 0.0066 | 6.21 |
| Tenvermectin | 1.999X | | | | |
| B | | | | | |

As can be seen from Table 5, abamectin was used as a standard agent, the relative toxicity index thereof was set to be 1, and the relative toxicity indexes of tenvermectin A and B were 4.77 and 6.21 respectively, the toxicity of tenvermectin A and B were much higher than that of abamectin. Tenvermectin B had higher activity against Coptotermes formosanus Shiraki and was superior to the other two agents.

### Example 6: Field Efficacy Test Against Cnaphalocrocis medinalis of Tenvermectin

Test agents:

92% Abamectin (Zhejiang Qianjiang Biochemical Co., Ltd.);

95% Tenvermectin A (Zhejiang Hisun Pharmaceutical Co., Ltd.);

92% Tenvermectin B (Zhejiang Hisun Pharmaceutical Co., Ltd.).

In the laboratory, the above-mentioned original medicines were respectively formulated to the following preparations for later use: 1.8% abamectin emulsifiable concentrate, 1.8% tenvermectin emulsifiable concentrate A (single component: tenvermectin A, wherein the content of the impurity: tenvermectin B component was 0.02%), 1.8% tenvermectin emulsifiable concentrate B (tenvermectin A: tenvermectin B=9:1 (weight ratio, the same below)), 1.8% tenvermectin emulsifiable concentrate C (tenvermectin A: tenvermectin B=5:1), 1.8% tenvermectin emulsifiable concentrate D (tenvermectin A: tenvermectin B=1:1), 1.8% tenvermectin emulsifiable concentrate E (single component: tenvermectin B, wherein the content of the impurity: tenvermectin A was 0.51%). The test crop was rice, the variety was late rice Longping 48, and the object to be controlled was Cnaphalocrocis medinalis.

The experiment consisted of 7 treatments, 4 replicates per treatment, 28 sections in total. The sections were randomly arranged, the area for each section was 66.7 m². The rice was well managed, and the watering and fertilization and management conditions of each test section were consistent. A type of knapsack manual sprayer was used to spray once, the amount of each section was calculated according to the amount of 40 ml/mu, and the leaves were sprayed evenly. Each treatment was isolated from each other to avoid mutual interference. A blank control was set, and the blank control was sprayed with water. Rice was at the booting stage, the fourth generation of Cnaphalocrocis medinalis, peak stage, 1-2 instars. Investigation was conducted 14 days after medication, 5-point samplings were taken, 5 clusters of rice were taken continuously for each point, and a total of 25 clusters were investigated in each section. The rate of leaf rolling was investigated and the control effect was calculated. The test results are shown in Table 6.

Calculation formula for the control effect of Cnaphalocrocis medinalis:

$$Relative control effect \text{/} \% = \frac{\begin{matrix}Leaf rolling rate of control section - \\ Leaf rolling rate of treatment area\end{matrix}}{Leaf rolling rate of control section} \times 100$$

TABLE 6
Field test results for controlling Cnaphalocrocis medinalis

| | Leaf | Relative | Significance | |
|---|---|---|---|---|
| | rolling | control | of | |
| | rate | effect | difference* | |
| Test agent | (%) | (%) | 5% | 1% |
| 1.8% Abamectin emulsifiable | 1.05 | 78.74 | b | B |
| concentrate | | | | |
| 1.8% Tenvermectin emulsifiable | 0.26 | 94.74 | a | A |
| concentrate A | | | | |
| 1.8% Tenvermectin emulsifiable | 0.34 | 93.12 | a | A |
| concentrate B | | | | |
| 1.8% Tenvermectin emulsifiable | 0.21 | 95.75 | a | A |
| concentrate C | | | | |
| 1.8% Tenvermectin emulsifiable | 0.31 | 93.72 | a | A |
| concentrate D | | | | |
| 1.8% Tenvermectin emulsifiable | 0.29 | 94.13 | a | A |
| concentrate E | | | | |
| Control | 4.94 | — | — | — |

*Wherein the same letter in the column of significance of difference indicates no significant difference.

The test results showed that when tenvermectin A and tenvermectin B were mixed in different weight ratios (tenvermectin A single component, tenvermectin A: tenvermectin B=9:1, tenvermectin A: tenvermectin B=5:1, tenvermectin A: tenvermectin B=1:1, tenvermectin B single component), they had significant control effects on Cnaphalocrocis medinalis, the control effects of them were all above 90% and were better than the equivalent dose of abamectin, and the control effects on Cnaphalocrocis medinalis of various ratios of tenvermectin mixtures were similar.

### Example 7: Field Efficacy Test Against Rice Chilo suppressalis of Tenvermectin

Test agents:

92% Abamectin (Zhejiang Qianjiang Biochemical Co., Ltd.);

95% Tenvermectin A (Zhejiang Hisun Pharmaceutical Co., Ltd.);

92% Tenvermectin B (Zhejiang Hisun Pharmaceutical Co., Ltd.).

In the laboratory, the above-mentioned original medicines were respectively formulated to the following preparations for later use: 1.8% abamectin emulsifiable concentrate, 1.8% tenvermectin emulsifiable concentrate A (single component: tenvermectin A, wherein the content of the impurity: tenvermectin B component was 0.02%), 1.8% tenvermectin emulsifiable concentrate B (tenvermectin A: tenvermectin B=9:1 (weight ratio, the same below)), 1.8% tenvermectin emulsifiable concentrate C (tenvermectin A: tenvermectin B=5:1), 1.8% tenvermectin emulsifiable concentrate D (tenvermectin A: tenvermectin B=1:1), 1.8% tenvermectin emulsifiable concentrate E (single component: tenvermectin B, wherein the content of the impurity: tenvermectin A was 0.51%). The test crop was rice, the variety was late rice Ning 84, and the object to be controlled was rice Chilo suppressalis.

The experiment consisted of 7 treatments, 4 replicates per treatment, 28 sections in total. The sections were randomly arranged, the area for each section was 66.7 m². The rice was well managed, and the watering and fertilization and management conditions of each test section were consistent. A type of knapsack manual sprayer was used to spray once, the amount of each section was calculated according to the amount of 40 ml/mu, and the leaves were sprayed evenly. Each treatment was isolated from each other to avoid mutual interference. A blank control was set, and the blank control was sprayed with water. Rice was at the tillering stage, the third generation of rice Chilo suppressalis, peak stage, 1 instar. Investigation was conducted 15 days after medication, 5-point samplings were taken, 5 clusters of rice were taken continuously for each point, and a total of 25 clusters were investigated in each section. The dead heart rate was investigated and the control effect was calculated. The test results are shown in Table 7.

Calculation formula for the control effect of rice Chilo suppressalis:

$$Relative control effect \text{/} \% = \frac{\begin{matrix}Damage rate of control section - \\ Damage rate of treatment section\end{matrix}}{Damage rate of control area} \times 100$$

TABLE 7
Field test results for controlling rice Chilo suppressali

| | Dead | Relative | Significance | |
|---|---|---|---|---|
| | heart | control | of | |
| | rate | effect | difference* | |
| Test agent | (%) | (%) | 5% | 1% |
| 1.8% Abamectin emulsifiable | 2.07 | 75.65 | b | B |
| concentrate | | | | |
| 1.8% Tenvermectin emulsifiable | 1.27 | 85.06 | a | A |
| concentrate A | | | | |
| 1.8% Tenvermectin emulsifiable | 1.26 | 85.18 | a | A |
| concentrate B | | | | |
| 1.8% Tenvermectin emulsifiable | 1.20 | 85.88 | a | A |
| concentrate C | | | | |
| 1.8% Tenvermectin emulsifiable | 1.33 | 84.35 | a | A |
| concentrate D | | | | |
| 1.8% Tenvermectin emulsifiable | 1.40 | 83.53 | a | A |
| concentrate E | | | | |
| Control | 8.5 | — | — | — |

*Wherein the same letter in the column of significance of difference indicates no significant difference.

The test results showed that when tenvermectin A and tenvermectin B were mixed in different weight ratios (tenvermectin A single component, tenvermectin A: tenvermectin B=9:1, tenvermectin A: tenvermectin B=5:1, tenvermectin A: tenvermectin B=1:1, tenvermectin B single component), they had significant control effects on rice Chilo suppressali, the control effects of them were all above 80% and were better than the equivalent dose of abamectin, and the control effects on rice Chilo suppressali of various ratios of tenvermectin mixtures were similar.

### Example 8: Indoor Efficacy Test Against Rice Scirpophaga Incertalas of Tenvermectin

Test agents:

92% Abamectin (Zhejiang Qianjiang Biochemical Co., Ltd.);

95% Tenvermectin A (Zhejiang Hisun Pharmaceutical Co., Ltd.);

92% Tenvermectin B (Zhejiang Hisun Pharmaceutical Co., Ltd.).

In the laboratory, the above-mentioned original medicines were respectively formulated to the following preparations for later use: 1.8% abamectin emulsifiable concentrate, 1.8% tenvermectin emulsifiable concentrate A (single component: tenvermectin A, wherein the content of the impurity: tenvermectin B component was 0.02%), 1.8% tenvermectin emulsifiable concentrate B (tenvermectin A: tenvermectin B=9:1 (weight ratio, the same below)), 1.8% tenvermectin emulsifiable concentrate C (tenvermectin A: tenvermectin B=5:1), 1.8% tenvermectin emulsifiable concentrate D (tenvermectin A: tenvermectin B=1:1), 1.8% tenvermectin emulsifiable concentrate E (single component: tenvermectin B, wherein the content of the impurity: tenvermectin A was 0.51%).

The test crop was rice, the variety was late rice Ning 84, experiments were carried out with seedlings about 10 days after sowing.

The eggs of rice Scirpophaga incertalas were harvested from rice in the paddy fields and were dispensed in test tubes. When the eggs of rice Scirpophaga incertalas were hatched, they were immediately attached to the rice leaves that had been sprayed with the agents. Each test agent was diluted 2000 times, and was sprayed to uniformly apply the agent on the front and back sides of the leaf, until dripping. 10 seedlings were planted per pot, and each seedling inoculated one head of insect. The control effects of 6 agents were investigated in total. Each agent was conducted with 4 replicates, and three pots of rice seedlings per replicate. Each treatment was isolated from each other to avoid mutual interference. A blank control was set, and the blank control was sprayed with nothing. The number of dead hearts and the number of plants damaged by insects were investigated 15 days after inoculation. The test results are shown in Table 8.

Calculation formula for the indoor control effect of rice Scirpophaga incertalas:

$$Relative control effect \text{/} \% = \frac{\begin{matrix}Damage rate of control section - \\ Damage rate of treatment section\end{matrix}}{Damage rate of control section} \times 100$$

TABLE 8
Indoor test results for controlling rice Scirpophaga incertalas

| | | Relative | Significance | |
|---|---|---|---|---|
| | Damage | control | of | |
| | rate | effect | difference* | |
| Test agent | (%) | (%) | 5% | 1% |
| 1.8% Abamectin emulsifiable | 20.83 | 78.45 | b | B |
| concentrate | | | | |
| 1.8% Tenvermectin emulsifiable | 9.17 | 90.51 | a | A |
| concentrate A | | | | |
| 1.8% Tenvermectin emulsifiable | 8.33 | 91.38 | a | A |
| concentrate B | | | | |
| 1.8% Tenvermectin emulsifiable | 7.5 | 92.24 | a | A |
| concentrate C | | | | |
| 1.8% Tenvermectin emulsifiable | 6.67 | 93.10 | a | A |
| concentrate D | | | | |
| 1.8% Tenvermectin emulsifiable | 6.67 | 93.10 | a | A |
| concentrate E | | | | |
| Control | 96.67 | — | — | — |

*Wherein the same letter in the column of significance of difference indicates no significant difference.

The test results showed that when tenvermectin A and tenvermectin B were mixed in different weight ratios (tenvermectin A single component, tenvermectin A: tenvermectin B=9:1, tenvermectin A: tenvermectin B=5:1, tenvermectin A: tenvermectin B=1:1, tenvermectin B single component), they had significant control effects on rice Scirpophaga incertulas, the control effects of them were all above 90% and were better than the equivalent dose of abamectin, and the control effects on rice Scirpophaga incertulas of various ratios of tenvermectin mixtures were similar.

### Example 9: Toxicity Tests of Tenvermectin a on Zebrafish

As a sensitive model organism, zebrafish was sensitive to a variety of environmental pollutants and was widely used in various ecological risk assessments.

Test fish and water: zebrafish (Brachydanio rerio) were purchased from Zhejiang Academy of Agricultural Sciences and were of uniform size with an average body length of 2-3 cm and an average body weight of 0.3 g. They were domesticated for 7 days indoors before the test. The natural mortality rate was zero. Feeding was stopped 1 day before the test and the fish were not fed during the test. The test water was tap water after removing residual chlorine by exposure to the sun for more than 24 hours, and the pH was 6.8.

Test agents:

99.4% Tenvermectin A (the mass content of tenvermectin B was 0.02%) (Zhejiang Hisun Pharmaceutical Co., Ltd.);

Tenvermectin (the mass ratio of tenvermectin A/tenvermectin B was 95/5) (Zhejiang Hisun Pharmaceutical Co., Ltd.);

Tenvermectin (the mass ratio of tenvermectin A/tenvermectin B was 90/10) (Zhejiang Hisun Pharmaceutical Co., Ltd.);

Tenvermectin (the mass ratio of tenvermectin A/tenvermectin B was 85/15) (Zhejiang Hisun Pharmaceutical Co., Ltd.);

99.1% Tenvermectin B (the mass content of tenvermectin A was 0.51%) (Zhejiang Hisun Pharmaceutical Co., Ltd.);

92% Abamectin (Zhejiang Qianjiang Biochemical Co., Ltd.);

91% Milbemycin (Zhejiang Hisun Pharmaceutical Co., Ltd.);

96% Ivermectin (Zhejiang Hisun Pharmaceutical Co., Ltd.);

90% Methylamino abamectin benzoate (Emamectin benzoate) (Zhejiang Shenghua Biok Biology Co., Ltd.).

The sample was formulated into 50 mg/ml mother liquor with DMF.

Method: Semi-static method. Three level differences were set for each sample:

0.5 ppm, 1.0 ppm and 2.0 ppm, and three sets of parallels were set for each level difference, 10 zebrafish were raised for each group, and blank controls (one group without agents and one group with only solvent) were set. The corresponding volume of mother liquor was taken according to the concentration as required for each sample, and the volume of each sample was adjusted to 150 μl with DMF, and then each sample was added to the test group (containing 1.6 L of water). The room temperature was controlled at 22±2° C. for 96 hours, and the water was changed every 24 hours and the samples were re-added. The fish mortality rate was recorded for the first 8 hours and at 24, 48, 72, and 96 hours, and the dead fish were removed in time. Finally, the agents were divided into three grades according to the values of LC₅₀: low-toxic pesticides with a LC₅₀>10 ppm, middle-toxic pesticides with a LC₅₀ of 1.0-10 ppm, and high-toxic pesticides with a LC₅₀<1.0 ppm. The test results are shown in Table 9.

TABLE 9
Toxicity tests of different agents on zebrafish

| | | | Surviving condition | | | | |
|---|---|---|---|---|---|---|---|
| | | Concen- | (survival rate %) | | | | |
| | | tration | 8 | 24 | 48 | 72 | 96 |
| No. | Agent | (ppm) | h | h | h | h | h |
| 1 | 99.4% | 0.5 | 100 | 100 | 100 | 100 | 100 |
| | Tenvermectin A | 1.0 | 100 | 100 | 100 | 100 | 100 |
| | | 2.0 | 100 | 100 | 100 | 93 | 80 |
| 2 | Tenvermectin | 0.5 | 100 | 100 | 100 | 100 | 100 |
| | A/B = 95:5 | 1.0 | 100 | 100 | 100 | 100 | 100 |
| | | 2.0 | 100 | 83 | 50 | 27 | 10 |
| 3 | Tenvermectin | 0.5 | 100 | 100 | 100 | 100 | 100 |
| | A/B = 90:10 | 1.0 | 100 | 100 | 93 | 80 | 67 |
| | | 2.0 | 77 | 50 | 33 | 10 | 0 |
| 4 | Tenvermectin | 0.5 | 100 | 100 | 100 | 100 | 100 |
| | A/B = 85:15 | 1.0 | 100 | 77 | 60 | 40 | 17 |
| | | 2.0 | 60 | 33 | 0 | | |
| 8 | 99.1% | 0.5 | 100 | 70 | 50 | 0 | |
| | Tenvermectin B | 1.0 | 53 | 0 | | | |
| | | 2.0 | 10 | 0 | | | |
| 9 | 92% Abamectin | 0.5 | 0 | | | | |
| | | 1.0 | 0 | | | | |
| | | 2.0 | 0 | | | | |
| 10 | 91% Milbemycin | 0.5 | 0 | | | | |
| | | 1.0 | 0 | | | | |
| | | 2.0 | 0 | | | | |
| 11 | 96% Ivermectin | 0.5 | 0 | | | | |
| | | 1.0 | 0 | | | | |
| | | 2.0 | 0 | | | | |
| 12 | 90% Methylamino | 0.5 | 0 | | | | |
| | abamectin benzoate | 1.0 | 0 | | | | |
| | (Emamectin | 2.0 | 0 | | | | |
| | benzoate) | | | | | | |

The results showed that the 96-hour survival rate of zebrafish was still greater than 50% when the concentration of tenvermectin A: tenvermectin B=90:10 was 1 ppm, indicating that the 96-hour LC₅₀ of tenvermectin A: tenvermectin B=90:10 on zebrafish was >1 ppm, tenvermectin A: tenvermectin B=90:10 was middle-toxic; and the toxicity of tenvermectin to zebrafish decreased as the proportion of component A increased. When abamectin, ivermectin, milbemycin and emamectin benzoate were at 0.5 ppm, the 8-hour survival rates of zebrafish were all 0, indicating that the 96-hour LC₅₀ of abamectin, the 96-hour LC₅₀ of ivermectin, the 96-hour LC₅₀ of milbemycin and the 96-hour LC₅₀ of emamectin benzoate on zebrafish were <0.5 ppm, abamectin, ivermectin, milbemycin and emamectin benzoate were high-toxic.

### Example 10: Field Efficacy Test Against Cabbage Phyllotreta of Tenvermectin

Test agents:

95% Tenvermectin A (Zhejiang Hisun Pharmaceutical Co., Ltd.);

92% Tenvermectin B (Zhejiang Hisun Pharmaceutical Co., Ltd.).

98% Imidacloprid (Zhejiang Hisun Chemical Co., Ltd.);

99% Acetamiprid (Zhejiang Hisun Chemical Co., Ltd.);

95% Lambda-cyhalothrin (Jiangsu Jianpai Pesticide Chemical Co., Ltd.).

In the laboratory, the above-mentioned original medicines were respectively formulated into the following formulations for later use: 1.8% abamectin emulsifiable concentrate, 1.8% tenvermectin A emulsifiable concentrate, 1.8% tenvermectin B emulsifiable concentrate, 5% imidacloprid emulsifiable concentrate, 5% acetamiprid emulsifiable concentrate, 2.5% lambda-cyhalothrin emulsifiable concentrate.

The test was conducted in Linhai City, and the test crop was cabbage, and the object to be controlled was Phyllotreta.

The experiment consisted of 7 treatments, 3 replicates per treatment, 21 sections in total. The sections were randomly arranged, the area for each section was 66.7 m². A type of knapsack manual sprayer was used to spray once, the amount of each section was calculated according to the amount of 50 ml/mu, and the leaves were sprayed evenly. Each treatment was isolated from each other to avoid mutual interference. A blank control was set, and the blank control was sprayed with water. The population base of insects was investigated before medication, and the number of live insects was investigated 1 day, 3 days, and 7 days after medication, and a total of 4 investigations were conducted. 20 plants were randomly investigated per section. The rate of reduction of population was calculated and the control effect was corrected. No other pesticides were used during the test. The test results are shown in Table 10.

$$Corrected control effect = \frac{\begin{matrix}Rate of reduction of treatment section - \\ Rate of reduction of control section\end{matrix}}{100 - Rate of reduction of control section} \times 100 \%$$

$$Rate of reduction of population = \frac{{Pt}_{0} insect number - {Pt}_{1} insect number}{{Pt}_{0} insect number} \times 100 \%$$

Pt₀: insect number before medication; Pt₁: insect number after medication.

TABLE 10
Field test results for controlling cabbage Phyllotreta

| | 1 day after | | 3 days after | | 7 days after | |
|---|---|---|---|---|---|---|
| | medication | | medication | | medication | |
| | Rate of | Relative | Rate of | Relative | Rate of | Relative |
| | reduction of | control | reduction of | control | reduction of | control |
| | population | effect | population | effect | population | effect |
| Test agent | (%) | (%) | (%) | (%) | e (%) | (%) |
| 1.8% Tenvermectin A | −1.2 | 1.8 | −5.7 | 1.7 | −15.1 | 0 |
| emulsifiable concentrate | | | | | | |
| 1.8% Tenvermectin B | −2.3 | 0 | −6.7 | 0 | −15.7 | 0 |
| emulsifiable concentrate | | | | | | |
| 5% Imidacloprid | 76.3 | 77 | 71.3 | 73.3 | 61.6 | 66.8 |
| emulsifiable concentrate | | | | | | |
| 5% Acetamiprid | 63.2 | 64.3 | 58.2 | 61.1 | 51.1 | 57.8 |
| emulsifiable concentrate | | | | | | |
| 2.5% Lambda-cyhalothrin | 71.4 | 72.3 | 66.9 | 69.2 | 58 | 63.7 |
| emulsifiable concentrate | | | | | | |
| Control | −3.1 | 0 | −7.5 | 0 | −15.8 | — |

The test results showed that basically, tenvermectin A and tenvermectin B had no control effect on cabbage Phyllotreta 1 day, 3 days and 7 days after medication, and the control effects were obviously inferior to other agents.

Uses of tenvermectin of the present application have been described by specific examples, and those skilled in the art can learn from the contents of the present application and appropriately change the raw materials, process conditions and the like to achieve the other corresponding purposes, and the related changes do not deviate from the content of the present invention. All similar substitutions and modifications are obvious to those skilled in the art and are considered to be included within the scope of the present invention.

1. A method of preventing and treating human or animal parasites, the method comprising:
administering one compound or a mixture of two compounds of formula (I) to agricultural and forest crops: 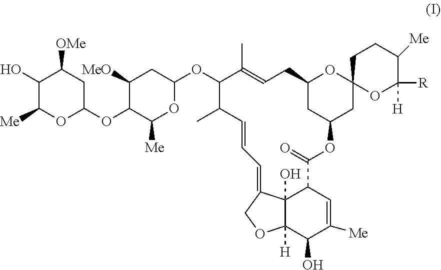
wherein R is selected from CH₃ and C₂H₅, and
wherein the compound is tenvermectin A when R is —CH₃, and the compound is tenvermectin B when R is —C₂H₅.

2. The method according to claim 1, wherein the agricultural and forest crop is selected from the group consisting of rice, cotton, tea, vegetables, sugarcane, soybeans, potatoes, fruit trees, fruits of fruit trees, corn, vines, ornamental plants, pasture and herbage, canola, and any combination thereof.

3. The method according to claim 1, wherein the harmful insect is selected from the group consisting of Blattaria, Phthiraptera, Thysanoptera, Homoptera, Hemiptera, Hymenoptera, Diptera, Siphonaptera, plant parasitic nematodes, oriental armyworm, gamasid mite, Eriophyidae, and any combination thereof.

4. The method according to claim 1, wherein the harmful insect is selected from the group consisting of Bemisia tabaci, Frankliniella occidentalis Pergande, Laodelphax striatellus, Nilaparvata lugens, Sogatella furcifera, Cnaphalocrocis medinalis, rice Chilo suppressalis, rice Scirpophaga incertulas, Coptotermes formosanus Shiraki, and any combination thereof.

5. The method according to claim 1, wherein the harmful insect is selected from the group consisting of Laodelphax striatellus, Nilaparvata lugens, Sogatella furcifera, Cnaphalocrocis medinalis, rice Chilo suppressalis, rice Scirpophaga incertulas, and combinations thereof.

6. The method according to claim 1, wherein the harmful insect is Laodelphax striatellus, Nilaparvata lugens or Sogatella furcifera.

7. The method according to claim 1, wherein a mixture of tenvermectin A and tenvermectin B is administered to agricultural and forest crops.

8. The method according to claim 2, wherein the agricultural and forest crop is selected from the group consisting of rice, cotton, vegetables, fruit trees, ornamental plants, and any combination thereof.

9. The method according to claim 3, wherein the harmful insect is selected from the group consisting of Blattaria, Thysanoptera, Homoptera, Hemiptera, and any combination thereof.

10. The method according to claim 7, wherein a weight ratio of tenvermectin A to tenvermectin B is ≥9:1.

11. The method according to claim 7, wherein a weight ratio of tenvermectin A to tenvermectin B is ≥19:1.
